(19) United States
(12) Patent Application Publication
(10) Pub. No.: US 2017/0243263 A1
(43) Pub. Date: Aug. 24, 2017

(54) BILLING CONSUMPTION OF CLOUD-BASED RESOURCES

(71) Applicant: HEWLETT PACKARD ENTERPRISE DEVELOPMENT LP, Houston, TX (US)

(72) Inventor: Phani Kumar VEDALA, Bangalore (IN)

(73) Assignee: HEWLETT PACKARD ENTERPRISE DEVELOPMENT LP, Houston, TX (US)

(21) Appl. No.: 15/500,069

(22) PCT Filed: Sep. 19, 2014
(86) PCT No.: PCT/US2014/056600

§ 371 Date: Jan. 30, 2017

(30) Foreign Application Priority Data
Aug. 1, 2014 (IN) 3792/CHE/2014

(51) Int. Cl. G06Q 30/04

(52) U.S. Cl. CPC G06Q 30/04

(57) ABSTRACT

Some examples described herein relate to billing consumption of cloudbased resources. Topology maps of resources assigned to a user on a cloud may be periodically generated. The topology maps may be used to determine resources consumed by the user during a particular period. A bill may be generated based on the resources consumed by the user during the particular period, wherein each of the resources is billed only for a duration it is consumed in the particular period.

### BACKGROUND

An increasing number of enterprises are adopting cloud computing based solutions. Generally speaking, cloud computing involves delivery of computing as a service rather than a product, whereby shared resources (software, storage resources, etc.) are provided to computing devices as a service. The resources are shared over a network such as the internet. Cloud computing thus provides a quick and scalable access to computing resources and information technology (IT) services.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing environment for billing consumption of cloud-based resources;

FIGS. 2A and 2B are diagrams of example topology maps of cloud-based resources assigned to a user;

FIG. 3 is a flow chart of an example method for billing consumption of cloud-based resources; and

FIG. 4 is a block diagram of an example system for billing consumption of cloud-based resources.

### DETAILED DESCRIPTION OF THE INVENTION

Cloud computing is a delivery model for technology-enabled services that provides on-demand and pay-as-you-use access to an elastic pool of shared computing resources. Some examples of such resources may include applications, servers, storage, networks, etc. Cloud computing allows rapid provisioning of computing resources that could be scaled up or down depending on the requirements of a customer. Thus, these assets may be consumed “as a service”.

There are many models of cloud computing such as Infrastructure-as-a-Service (IaaS), Platform-as-a-Service (PaaS) and Software-as-a-Service (SaaS). Depending on a client's requirement, a cloud service provider may provide either of the aforementioned services each of which may require provisioning of certain resources on a cloud. For instance, in case of a client request for deployment of an application (for example, an email application) on a cloud, a cloud service provider may provision infrastructure resources (for example, a virtual server) and platform resources in order to deploy the application.

There may be a scenario where a user or customer's use of cloud-based resources may vary over time. For instance, a customer may request additional resources (for example, storage resources, processing resources, network resources, etc.) for various reasons, such as for meeting a Service Level Agreement (SLA), improved service performance, scalability, etc. Likewise, a user may request withdrawal of resources assigned to it for reasons, such as adverse business conditions, change in business model, costs, etc. In either case, a cloud service provider would be expected to provision or withdraw cloud-based resources accordingly, based on customer's request. Thus, usage of cloud-based resources or services by customers in a cloud may not be static, and a cloud service provider may need to be responsive to such a dynamic environment. In such scenario, a cloud service provider may require an effective mechanism to bill customers accurately for the actual consumption of resources over a period of time.

The present disclosure describes various examples for billing consumption of cloud-based resources. Periodic topology maps of resources assigned to a user on a cloud may be generated. The topology maps may be used to determine resources consumed by the user during a particular period. A bill may be generated based on the resources consumed by the user during the particular period, wherein each of the resources is billed only for the duration it is consumed in the particular period.

As user herein, the term “user” may include a living entity (such as, an individual) or a non-living entity (such as, an enterprise, a business unit, an application, and the like).

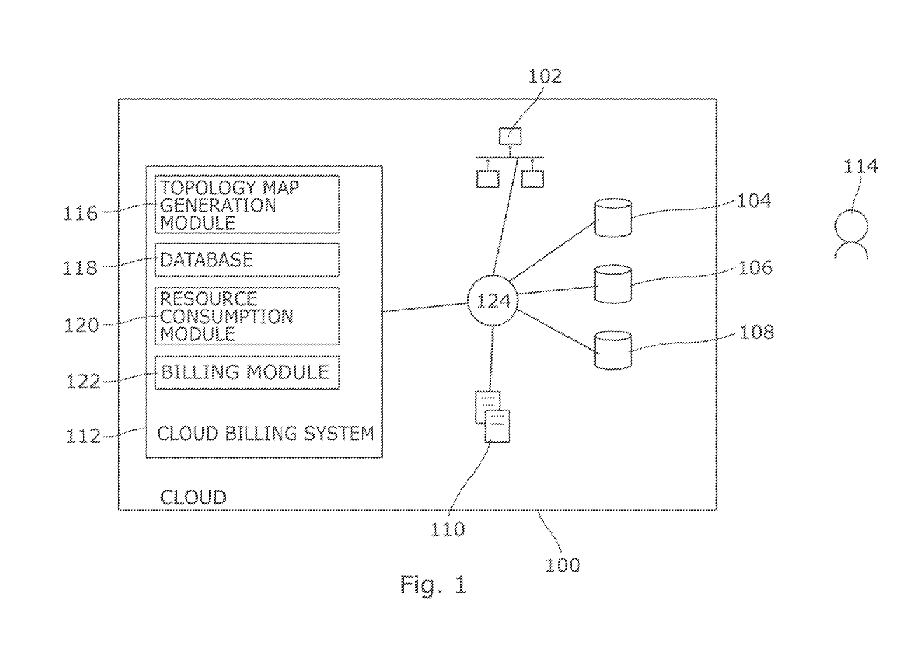

FIG. 1 is a block diagram of an example computing environment 100 for billing consumption of cloud-based resources. In an example, computing environment 100 may be a cloud network or cloud system (“cloud”) that may be a private cloud, a public cloud, or a hybrid cloud. To explain briefly, a cloud system 100 may be termed as public cloud if cloud computing services are rendered over a public network such as the internet. On the other hand, a private cloud is a proprietary network that supplies services to a specific set of users. A hybrid cloud combines private and public cloud services.

Cloud system 100 may provide or deploy various types of cloud services for a user or customer. These may include Infrastructure as a Service (IaaS), Platform as a Service (PaaS), Software as a Service (SaaS), and so forth. In order to provide an aforementioned service, a cloud may include various types of computing resources (i.e. “cloud-based resources”) such as 102, 104, 106, 108, and 110. These computing resources may be hardware resources, software resources, or any combinations thereof. For example, hardware resources may include computer systems, computer servers, workstations, or any other computer devices. And, software resources may include operating system software (machine executable instructions), firmware, and/or application software. Computing resources may also include virtual machines, virtual servers, storage resources, load balancers, firewalls, etc.

Cloud system 100 may be used by a user or customer to request a new cloud service and manage an existing cloud service. Users may also use the cloud system 100 to view status of a pending cloud service request, pending approvals, and approved service subscriptions. Users may also use the cloud system 100 to request modifications in a cloud service subscription, cancel a cloud service subscription, and perform other actions related to their cloud services. In other words, cloud system 100 may be used to design, publish, and manage a cloud service(s).

Cloud system 100 may include a cloud billing system 112. Cloud billing system 112 may be any type of computing system capable of reading machine-executable instructions. These may include, without limitation, a computer server, a virtual server, a desktop computer, a notebook computer, a tablet computer, a thin client, a mobile device, a personal digital assistant (PDA), a phablet, and the like. Cloud billing system 112 may be used to generate a bill for the resources consumed by a user on the cloud system 100. Cloud billing system 112 may be communicatively coupled to the resources assigned to a user via a network 124, which may be a public network (for example, the Internet) or a private network (for example, an intranet). In the example of FIG. 1, cloud billing system is communicatively coupled to storage resources 104, 106, and 108 that are assigned to a user 114 in the cloud system 100.

In an example, cloud billing system 112 may include a topology map generation module 116, a database 118, a resource consumption module 120, and a billing module 122. The term “module” may refer to a software component (machine executable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computing device.

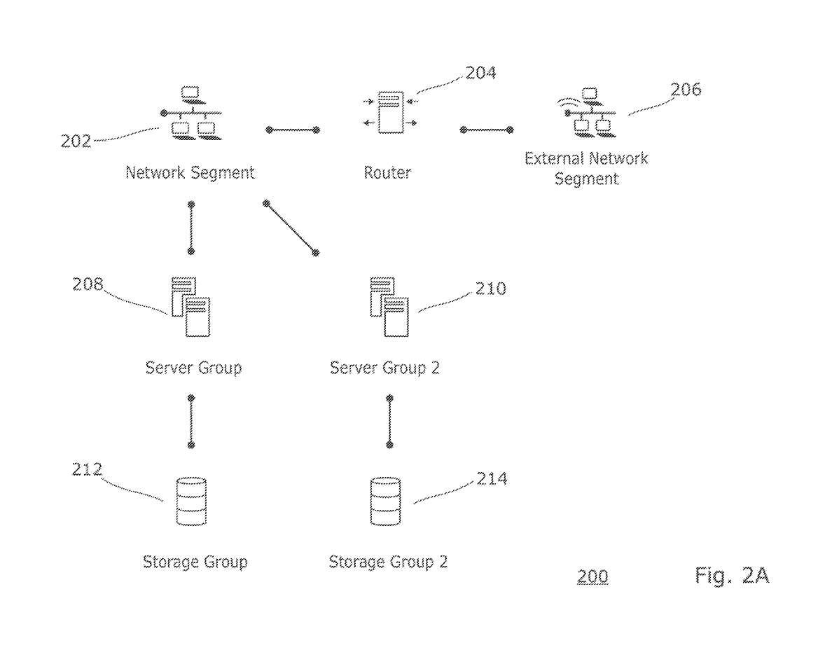

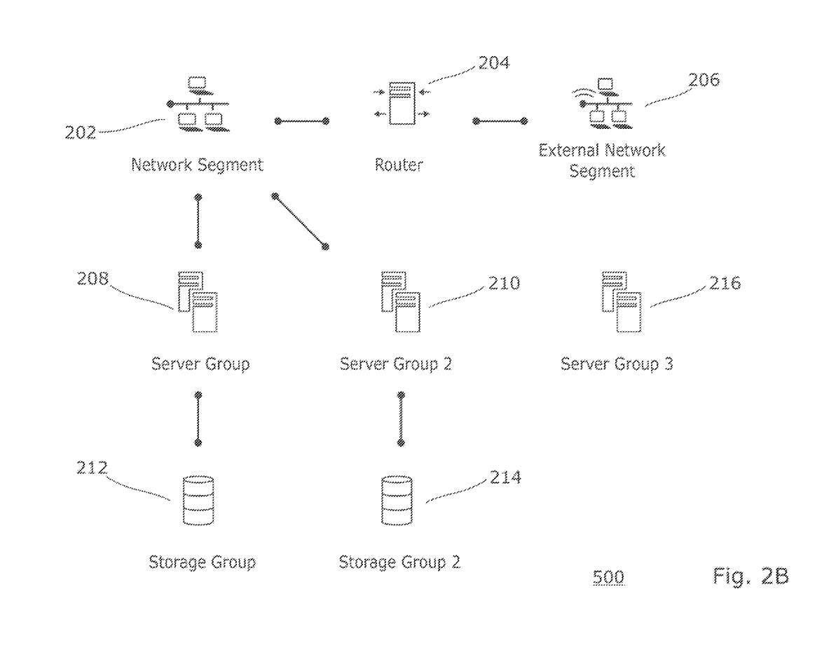

Topology generation module 116 may be used to generate a topology map of resources assigned to a user on a cloud (for example, 100). A topology map of resources may define physical or logical arrangement of resources assigned to a user on a cloud. It may include topology information related to the arrangement of cloud resources that are assigned to a user in a cloud system at a particular time. Said differently, a topology map of resources may be construed as a snapshot of cloud-based resources assigned to a customer. In an example, topology generation module 116 may periodically generate topology maps of resources assigned to a user (for example, 114). The time period for generating topology maps of resources that are assigned to a customer may include, by way of non-limiting examples, from an hour to a year. In other examples, this could period could be more or less. A user (example, 114) may request a cloud service provider for an additional cloud-based resource(s) or request withdrawal of a previously provisioned resource(s), from time to time. Generating topology map of resources periodically may enable a cloud service provider of the cloud system 100 to keep a track on the resources that are assigned to a user over a period of time. FIGS. 2A and 2B illustrate an example scenario where cloud-based resources that are assigned to a customer may change over a period of time. FIG. 2A illustrates an example topology map 200 of cloud resources that are assigned to a user. In this case, the topology map 200 includes various cloud-based resources (network segment 202, router 204, external network segment 206, server group 208, server group 2 (210), storage group 212, and storage group 2 (214)) and their relationships. If, over a period of time, a user requests for an additional resource, such as a server group, a cloud service provider may provision such resource to the user in the cloud system. FIG. 2B illustrates an example topology map 200 of cloud resources after an additional cloud-based resource (server group 3) is assigned to the user. In this case, the topology map 500 includes various cloud-based resources (network segment 202, router 204, external network segment 206, server group 2 (210), server group 3 (216), storage group 212, and storage group 2 (214)) and their relationships that were assigned to the user earlier. However, topology map 500 also captures the additional resource i.e. server group 3 (216) that is assigned to the user at a later time.

Topology generation module 116 may store the topology maps of cloud-based resources assigned to a user(s) in a database 118. Thus, database 118 may act as a repository where periodic topology maps of resources that are assigned to a customer on a cloud system may be stored. In an instance, database 118 may also store the date and/or time of generation of a topology map of resources assigned to a user. Thus, database may act as a repository for recording historical topology changes in the resources that are assigned to a user.

Resource consumption module 120 may utilize the periodic topology maps, stored in database 118, to determine resources consumed by a user during a particular period. As mentioned earlier, periodic topology maps of cloud-resources assigned to a user may be captured and stored in database 118; these may be used by resource consumption module 120 to identify consumption of cloud-based resources by a user. To provide an illustration, in the context of FIGS. 2A and 2B, let's assume that example topology map 200 of FIG. 2A is generated on July 1. In other words, as on July 1, a user may be assigned the following cloud-based resources: network segment 202, router 204, external network segment 206, server group 208, server group 2 (210), storage group 212, and storage group 2 (214). Now, let's assume that example topology map 500 of FIG. 2B is generated on July 15. This later topology map 500 may capture an additional cloud-based resource (server group 3) which is assigned to the user. In other words, as on July 15, a user may be assigned the following cloud-based resources: network segment 202, router 204, external network segment 206, server group 208, server group 2 (210), server group 3 (216), storage group 212, and storage group 2 (214). Resource consumption module 120 may analyze topology maps 200 and 500 to determine resources consumed by a user during a particular period. In the present example, resource consumption module 120 may determine that apart from earlier assigned resources (on July 1); an additional resource (server group 3) may be consumed by the user beginning July 15.

Billing module 122 may generate a bill for the cloud-resources consumed by a user (example, 114) during a particular period. In an example, billing module 122 may obtain information related to cloud-based resources consumed by a customer over a period of time from resource consumption module 120. The billing period may include, by way of non-limiting examples, a day, a month, and a year. In an instance, each of the cloud-based resources consumed by a user in a cloud system (example, 100) is billed only for the duration it is consumed in a particular period. In other words, billing module 122 may generate a bill based on actual consumption of cloud-based resources over a period. To provide an illustration, in the context of above-mentioned example, let's assume that the billing module 122 generates a bill for the cloud-resources (illustrated in FIGS. 2A and 2B) that are consumed by a user in a period of one month, on the last day of the month i.e. July 31. In such case, the billing module 122 may bill for the resources that are consumed during the entire month i.e. network segment 202, router 204, external network segment 206, server group 208, server group 2 (210), storage group 212, and storage group 2 (214), but may only bill for the resource “server group 3” for the duration between July 15 to July 31 (since said resource is assigned to the user from July 15). Likewise, in the event a user withdraws from consuming a cloud-based resource in-between a billing period, the billing module 122 may generate a bill for the consumption of a resource only for the duration it was consumed by a user.

In an example, cloud billing system may include a communication module (not shown) for transmitting a copy of the bill generated by billing module to a user. Communication module may send a copy of the bill to a customer over a network, which may be wired (example, Local Area Network) or wireless (example, Wi-fi).

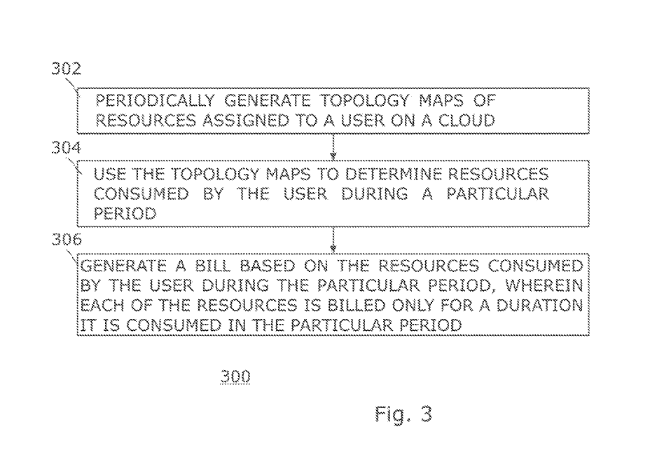

FIG. 3 is a flow chart of an example method 300 for billing consumption of cloud-based resources. The method 300, which is described below, may be executed on a computer server such as cloud billing system 112 of cloud system 100 of FIG. 1. However, other computing platforms may be used as well. At block 302, topology maps of resources assigned to a user on a cloud may be periodically generated. In an example, such periodic topology maps may be stored in a database. In another example, such periodic topology maps may be generated after an interval of, for example, a minute, an hour, a day, a month, or a year. At block 304, the topology maps may be used to determine resources consumed by the user during a particular period. At block 306, a bill may be generated based on the resources consumed by the user during the particular period, wherein each of the resources is billed only for a duration it is consumed in the particular period. In an example, the bill is sent to the user for payment of charges.

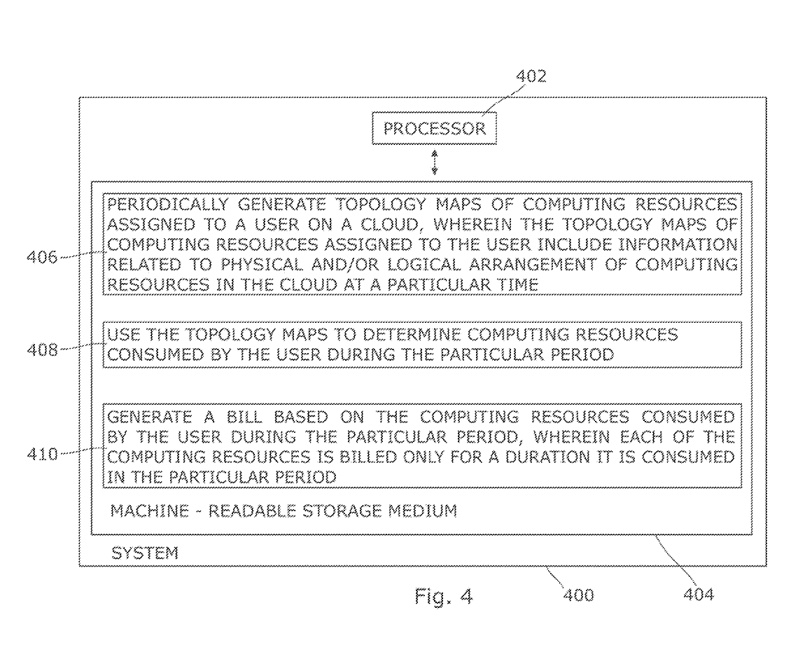

FIG. 4 is a block diagram of an example system 400 for billing consumption of cloud-based resources. System 400 includes a processor 402 and a machine-readable storage medium 404 communicatively coupled through a system bus. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium 404 may be a non-transitory machine-readable medium. In an example, machine- readable storage medium 404 may be remote but accessible to system 400.

In the example of FIG. 1, machine-readable storage medium 404 may store instructions 406, 408 and 410. In an example, instructions 406 may be executed by processor 402 to periodically generate topology maps of computing resources assigned to a user on a cloud. In an instance, topology maps of computing resources assigned to the user may include information related to physical and/or logical arrangement of computing resources in the cloud at a particular time. In an example, the computing resources may include processing resources, storage resources and/or network resources. Also, in an example, the user may include an individual, an enterprise, a business unit, or an application. Instructions 408 may be executed by processor 402 to use the topology maps to determine computing resources consumed by the user during a particular period. Instructions 410 may be executed by processor 402 to generate a bill based on the computing resources consumed by the user during the particular period, wherein each of the computing resources is billed only for a duration it is consumed in the particular period. Machine-readable storage medium 404 may further store installation instructions executable by processor 402 to store the topology maps of computing resources assigned to the user in a database. Machine-readable storage medium 404 may further store installation instructions executable by processor 402 to store the bill based on the computing resources consumed by the user during the particular period in a repository.

For the purpose of simplicity of explanation, the example method of FIG. 3 is shown as executing serially, however it is to be understood and appreciated that the present and other examples are not limited by the illustrated order. The example systems of FIGS. 1 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method for billing consumption of cloud-based resources, comprising:
periodically generating topology maps of resources assigned to a user on a cloud;
using the topology maps to determine resources consumed by the user during a particular period; and
generating a bill based on the resources consumed by the user during the particular period, wherein each of the resources is billed only for a duration it is consumed in the particular period.

2. The method of claim 1, wherein the topology maps of resources assigned to the user include information related to physical and/or logical arrangement of resources in the cloud at a particular time.

3. The method of claim 1, storing the topology maps of resources assigned to the user in a database.

4. The method of claim 1, further comprising storing date and time of generation of each of the topology map of resources in the database.

5. The method of claim 1, sending the bill to the user.

6. A system, comprising:
a topology map generation module to periodically generate topology maps of cloud-based resources assigned to a customer on a cloud;
a database to store the topology maps of cloud-based resources assigned to the customer;
a resource consumption module to determine, from the topology maps stored in the database, cloud-based resources consumed by the customer during a particular period; and
a billing module to generate a bill based on the cloud-based resources consumed by the customer during the particular period, wherein each of the cloud-based resources is billed only for a duration it is consumed in the particular period.

7. The system of claim 6, wherein the topology maps of cloud-based resources assigned to the customer include information related to physical and/or logical arrangement of cloud-based resources in the cloud.

8. The system of claim 6, further comprising a communication module to send the bill to the customer.

9. The system of claim 6, wherein the period for generating topology maps of cloud-based resources assigned to the customer includes one of an hour, a day, a month, and a year.

10. The system of claim 6, wherein the cloud is one of a private cloud, a public cloud, and a hybrid cloud.

11. A non-transitory machine-readable storage medium comprising instructions executable by a processor to:
periodically generate topology maps of computing resources assigned to a user on a cloud, wherein the topology maps of computing resources assigned to the user include information related to physical and/or logical arrangement of computing resources in the cloud at a particular time;
use the topology maps to determine computing resources consumed by the user during a particular period; and
generate a bill based on the computing resources consumed by the user during the particular period, wherein each of the computing resources is billed only for a duration it is consumed in the particular period.

12. The storage medium of claim 11, wherein the computing resources include processing resources, storage resources and/or network resources.

13. The storage medium of claim 11, wherein the user includes one of an individual, an enterprise, a business unit, and an application.

14. The storage medium of claim 11, further comprising instructions to store the topology maps of computing resources assigned to the user in a database.

15. The storage medium of claim 11, further comprising instructions to store the bill based on the computing resources consumed by the user during the particular period in a repository.
